(19) United States
(12) Patent Application Publication
(10) Pub. No.: US 2002/0140832 A1
(43) Pub. Date: Oct. 3, 2002

(54) Optimization of CCD microlens size for color balancing

(75) Inventor: Joseph R. Summa, Hilton, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/821,151

(22) Filed: Mar. 29, 2001

(51) Int. Cl. H04N 3/14; H04N 5/335; H04N 9/04; H04N 9/083

(52) U.S. Cl. 348/273; 348/340

(57) ABSTRACT

An image sensor comprises an array of pixels for collecting incident light and converting the light into an electrical charge; a color filter array having a plurality of colored filters positioned adjacent to the pixels for selectively transmitting specific spectral bands of light to the pixels; and a plurality of lenses positioned adjacent to individual pixels wherein the lenses positioned adjacent a first color of the colored filters are substantially larger in size than lenses adjacent a second color, such that a greater proportion of the incident light is focused onto the pixel adjacent the first color of the colored filter.

### FIELD OF THE INVENTION

This invention relates to electronic imaging, and more particularly, to the color sensitivity of individual pixels in a CCD.

### BACKGROUND OF THE INVENTION

A typical image sensor includes a plurality of photosensitive areas arranged in an array for collecting incident light and converting the incident light into an electrical charge. A color filter array having a plurality of colored filters is positioned over the photosensitive areas for selectively transmitting specific bands of light. The colored filters are typically made of three colors, such as red, green and blue, which are arranged in a predetermined color pattern.

A plurality of lenses is positioned over the color filters for focusing the light on the photosensitive area. As is well known in the art, the lenses are of substantially equal size and substantially equal shape.

The spectral response of the photosensitive area typically varies with the wavelength of the incident light. Typically, the spectral response of the photosensitive area peaks in the green and its lowest in the blue.

Although the commonly known and utilized image sensor is satisfactory, it includes drawbacks. The variation in the spectral response is undesirable because it hinders the accurate color reproduction of the color blue from the scene. Therefore, a need exists for an improved to image sensor having improved spectral response to the color blue.

### SUMMARY OF THE INVENTION

The present invention is directed to overcoming one or more of the problems set forth above. Briefly summarized, according to one aspect of the present invention, the invention resides in an image sensor comprising: (a) an array of pixels for collecting incident light and converting the light into an electrical charge; (b) a color filter array having a plurality of colored filters positioned adjacent to the pixels for selectively transmitting specific spectral bands of light to the pixels; and (c) a plurality of lenses positioned adjacent to individual pixels wherein the lenses positioned adjacent a first color of the colored filters are substantially larger in size than lenses adjacent a second color, such that a greater proportion of the incident light is focused onto the pixel adjacent the first color of the colored filter.

### Advantages over Prior Art

The present invention includes the advantages of improved color balance without significant loss of light, improved blue response, and less sensitivity to lens inefficiencies when applied to a fall frame CCD.

### BRIEF DESCRIPTION OF THE DRAWINGS

FIG. 1 is atop view of the imaging sensor of the present invention; and

FIG. 2 is a cross-sectional view along line A-A of FIG. 1.

### DETAILED DESCRIPTION OF THE INVENTION

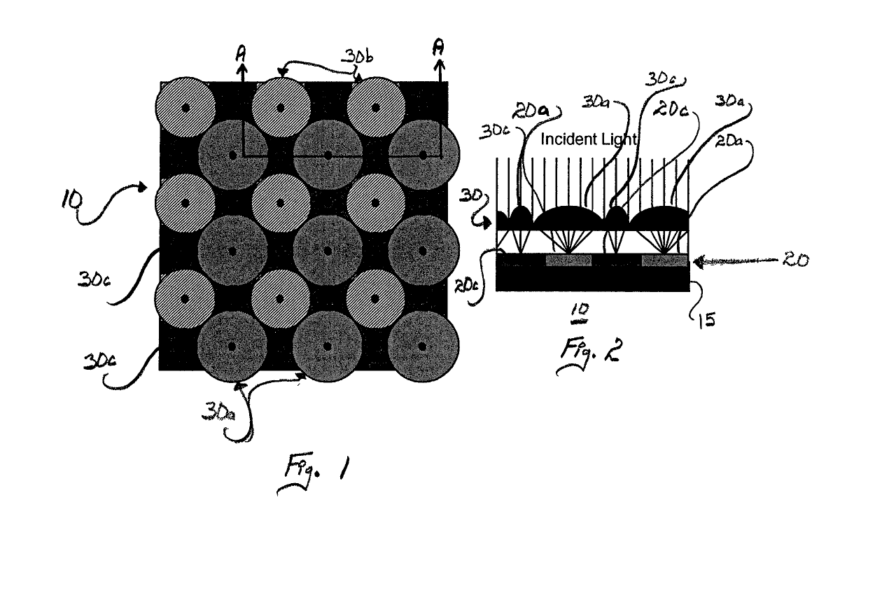

Referring to FIGS. 1 and 2, there is illustrated an imaging sensor 10 of the present invention. The imaging sensor 10 includes a substrate 15 having a photosensitive area at its upper portion for collecting the incident light. In the case of the interlined CCD, the photosensitive area is a photodiode. In the case of a full frame CCD, the photosensitive area is a charge-coupled device. As is well known in the art, the collected charges are transported out of the photosensitive area where the collected charge is converted into and electrical signal. This transporting and conversion process is well known in the art and will not be discussed herein.

A color filter array 20 is positioned over the substrate 15 for selectively transmitting specific wavelengths of light. The color filter array 20 includes a plurality of individual colored filters 20a and 20c arranged in a predetermined pattern. Typically, there are 3 differently colored filters, although only 2 are shown in FIG. 2 due to the position of the cross section. The filters 20a and 20c are typically red (not shown), green 20c and blue 20a (RGB).

A plurality of lenses 30 is positioned in a predetermined relationship over and adjacent the color filter array 20. The lenses 30 focus the incident light onto the photosensitive areas. As stated above, the color filter array 20 selectively transmits portions of the incident light to the photosensitive area. The lenses 30 are varied in size such that the lenses 30a over the blue-colored filters 20a are significantly larger than the lenses over other colors. Still further, the lenses 30b over the red colored filters (not shown in FIG. 2 due to the location of the cross-sectional line) are significantly larger than the lenses 30c over the green color filters 20c. The larger lenses 30a over the blue-colored filters collect a greater proportion of the incident light through their respective lenses. This enhances the blue sensitivity of the imaging sensor. The lenses 30b over the red colored filters collect a smaller proportion of the light than the lenses 30a over the blue color filters, but collected a greater proportion of the light than the lenses 30c over the green colored filters. As may be obvious to those skilled in the art, the size of the lenses may be varied in other proportions to meet the needs of the particular application.

The invention has been described in detail with particular reference to certain preferred embodiments thereof, but it will be understood that variations and modifications can be effected within the spirit and scope of the invention.

### PARTS LIST

10 imaging sensor

15 substrate

20 color filter array

20a individual colored filter

20c individual colored filter

30 plurality of lenses

30a lens

30b lens

30c lens

What is claimed is:

1. An image sensor comprising:
(a) an array of pixels for collecting incident light and converting the light into an electrical charge;
(b) a color filter array having a plurality of colored filters positioned adjacent to the pixels for selectively transmitting specific spectral bands of light to the pixels; and
(c) a plurality of lenses positioned adjacent to individual pixels wherein the lenses positioned adjacent a first color of the colored filters are substantially larger in size than lenses adjacent a second color, such that a greater proportion of the incident light is focused onto the pixel adjacent the first color of the colored filter.

2. The image sensor as in claim 1, wherein the color filters include a blue colored filter which is the first color in the color filter array.

3. The image sensor as in claim 2, wherein the colored filter includes red and green colored filters either of which is the second color.

4. The image sensor as in claim 1, wherein the colored filter includes a red colored filter which is the second color.

5. The image sensor as in claim 4, wherein the colored filter includes a green colored filter which is a third color and which green colored filter is substantially smaller in size than the red colored filter.
